(19) United States
(12) Patent Application Publication
(10) Pub. No.: US 2024/0416554 A1
(43) Pub. Date: Dec. 19, 2024

(54) POTTERY WHEEL WITH ARTICULATING THROWING ARM

(71) Applicant: IDEA VAULT HOLDINGS INC., Ashland, OR (US)

(72) Inventors: Howard Allen Wilson, IV, Medford, OR (US); Jordan Michael Willing, Ashland, OR (US); Jonathan David Willing, Ashland, OR (US); Michael E. Munter, Ashland, OR (US); Joshua J. Gedlick, Ashland, OR (US)

(21) Appl. No.: 18/743,095

(22) Filed: Jun. 13, 2024

Related U.S. Application Data
(60) Provisional application No. 63/472,793, filed on Jun. 13, 2023.

(51) Int. Cl. B28B 17/00

(52) U.S. Cl. CPC B28B 17/00

(57) ABSTRACT

According to one or more embodiments, a pottery wheel with an improved throwing arm for producing sculpted pottery, and more specifically, to an apparatus and method for producing customizable sculptured pottery using a pottery wheel having a throwing arm with appendage that articulates in multiple dimensions.

### CROSS-REFERENCE TO RELATED APPLICATION

This application claims priority to U.S. Provisional Patent Application Ser. No. 63/472,793 filed on Jun. 13, 2023, the entire disclosure of which is incorporated herein by reference.

### FIELD

The invention relates generally to an apparatus and method for producing sculpted pottery, and more specifically, to an apparatus and method for producing customizable sculptured pottery using a pottery wheel having a throwing arm with appendage that articulates in multiple dimensions.

### BACKGROUND

Sculptures molded from clay have been produced for thousands of years, both as works of art and as goods of a utilitarian nature. Traditionally, pottery has been sculpted into its desired shape by hand, an activity that takes many hours, and requires great artistic skill in order to produce an aesthetically pleasing final product. In recent years, a variety of tools and apparatuses have been developed to assist in the sculpting of clay pottery, including pottery wheels.

Pottery wheels, generally speaking, include spinning plates that rotate a block of clay about an axis to allow it to be molded into shape by the sculptor holding their hand stationary at a point in contact with the block. Tools may also be used to mold the clay as it rotates about an axis by contacting the perimeter of the clay at a particular point. Pottery wheels are especially useful for the production of circular shaped pieces such as pots or vases.

One of the challenges associated with the use of pottery wheels is the difficultly in centering the clay precisely in the center, or middle, of the spinning plate. If the block of clay is displaced from the center of the spinning plate in any direction, the clay may rupture or be sculpted into a non-symmetrical shape, producing an aesthetically displeasing final product. It also can result in excess waste, in which clay that ruptures due to being manipulated while off center is disposed of.

In order to address the difficulty in centering blocks of clay precisely in the center of the spinning plate, a number of tools have been used which mitigate the effect on clay due to it being displaced from the center, or to help center the clay. Tower attachments fixed at a position away from the spinning plate have been used to manipulate tools about the spinning plate. However, these attachments may fail to reliably center the clay in middle of the spinning plate, and often cause the clay to rupture.

Molds attached to a fixed location in the center of the spinning plate have also been used to attempt to better center the clay in the middle of the spinning plate. However, they offer only limited flexibility in the artwork that can be produced with them because they come in only a few shapes and sizes, often in the shape of a pot. They also tend to form the clay into a non-appealing shape because tools which are used over the mold often pierce the clay and cut all the way through it.

U.S. Patent Publication 2022/0143864, published May 12, 2022, the contents of which are hereby incorporated by reference, discloses a pottery wheel that allows an inexperienced user to learn to sculpture pottery using a throwing arm with limited degrees of freedom that assists the user to center and shape the mold. The pottery wheel includes a spinning plate on a housing and a throwing arm mounted on the housing outside the radius of the spinning plate. The throwing arm interchangeably attaches to various tools, such as a centering tool and shaping tool, one at a time, at a common attachment point that sits above the center of plate. The throwing arm has two pivot points, the first pivot point allowing it to pivot across the face of the spinning plate in a plane parallel to the face of the spinning plate, and the second pivot point allowing it to pivot towards and away from the face of the spinning plate. In this way, the pottery wheel enables the accurate and precise centering of clay in the middle of a spinning plate by a user of minimal skill, while not limiting the works of art being produced by the wheel.

While the foregoing pottery wheel provides numerous improvements over the prior art, more experienced users may desire a pottery wheel that includes a throwing arm with appendage that articulates in multiple dimensions, thereby enabling the user to produce pottery sculptures of increasing complexity.

### BRIEF DESCRIPTION OF THE DRAWINGS

FIG. 1 is a downward perspective view of a pottery wheel with an improved throwing arm, according to one or more embodiments of the present disclosure.

FIG. 2 is a downward view of a pottery wheel with an improved throwing arm, according to one or more embodiments of the present disclosure.

FIGS. 3A-4C are alternative perspective views of a pottery wheel with an improved throwing with an attachment in use, according to one or more embodiments of the present disclosure.

FIG. 4D is a perspective view of a pottery wheel with an improved throwing arm, according to one or more embodiments of the present disclosure.

FIG. 4E is another perspective view of a pottery wheel with an improved throwing arm, according to one or more embodiments of the present disclosure.

FIG. 4F is still another perspective view of a pottery wheel with an improved throwing arm, according to one or more embodiments of the present disclosure.

FIG. 5 shows the unassembled possible components of a pottery wheel with an improved throwing arm, according to one or more embodiments of the present disclosure.

FIG. 6A is a perspective view of a pottery wheel with an improved throwing arm, according to one or more embodiments of the present disclosure.

FIG. 6B is a side view of a speed throttle of a pottery wheel with an improved throwing arm, according to one or more embodiments of the present disclosure.

FIG. 6C is a perspective view of a pottery wheel with an improved throwing arm, according to one or more embodiments of the present disclosure.

FIG. 6D are alternative front views of a tool arm of a pottery wheel with an improved throwing arm, according to one or more embodiments of the present disclosure.

FIGS. 7A-7B are alternative side views of a speed throttle of a pottery wheel with an improved throwing arm, according to one or more embodiments of the present disclosure.

FIG. 7C is a wheel rotation button of a pottery wheel with an improved throwing arm, according to one or more embodiments of the present disclosure.

FIG. 7D shows a tool arm of a pottery wheel with an improved throwing arm, according to one or more embodiments of the present disclosure.

FIGS. 7E-7F shows exemplary tool attachments of a pottery wheel with an improved throwing arm, according to one or more embodiments of the present disclosure.

FIG. 7G is a sliding twist lock of a pottery wheel with an improved throwing arm, according to one or more embodiments of the present disclosure.

FIG. 7H is an exemplary handle lock of a pottery wheel with an improved throwing arm, according to one or more embodiments of the present disclosure.

FIG. 8A is a view of a pottery wheel with an improved throwing arm, according to one or more embodiments of the present disclosure.

FIG. 8B is a view of a pottery wheel with an improved throwing arm, according to one or more embodiments of the present disclosure.

FIG. 8C is a view of a pottery wheel with an improved throwing arm, according to one or more embodiments of the present disclosure.

FIG. 8D is a view of a pottery wheel with an improved throwing arm, according to one or more embodiments of the present disclosure.

FIG. 8E is a view of a pottery wheel with an improved throwing arm, according to one or more embodiments of the present disclosure.

FIG. 8F is a view of a pottery wheel with an improved throwing arm, according to one or more embodiments of the present disclosure.

FIG. 8G is a view of a pottery wheel with an improved throwing arm, according to one or more embodiments of the present disclosure.

FIG. 9A is a view of a pottery wheel with an improved throwing arm, according to one or more embodiments of the present disclosure.

FIG. 9B is a view of a pottery wheel with an improved throwing arm, according to one or more embodiments of the present disclosure.

FIG. 9C is a view of a pottery wheel with an improved throwing arm, according to one or more embodiments of the present disclosure.

FIG. 9D is a view of a pottery wheel with an improved throwing arm, according to one or more embodiments of the present disclosure.

FIG. 9E is a view of a pottery wheel with an improved throwing arm, according to one or more embodiments of the present disclosure.

FIG. 9F is a view of a pottery wheel with an improved throwing arm, according to one or more embodiments of the present disclosure.

FIG. 10A is a view of a pottery wheel with an improved throwing arm, according to one or more embodiments of the present disclosure.

FIG. 10B is a view of a pottery wheel with an improved throwing arm, according to one or more embodiments of the present disclosure.

FIG. 10C is a view of a pottery wheel with an improved throwing arm, according to one or more embodiments of the present disclosure.

FIG. 10D is a view of a pottery wheel with an improved throwing arm, according to one or more embodiments of the present disclosure.

FIG. 10E is a view of a pottery wheel with an improved throwing arm, according to one or more embodiments of the present disclosure.

FIG. 10F is a view of a pottery wheel with an improved throwing arm, according to one or more embodiments of the present disclosure.

FIG. 10G is a view of a pottery wheel with an improved throwing arm, according to one or more embodiments of the present disclosure.

### DETAILED DESCRIPTION

A pottery wheel with an improved throwing arm with appendage is disclosed that not only enables the user to readily center the clay but also allows multiple degrees of freedom for the user to engage the clay with various tools, thereby allowing the user the flexibility to create increasingly complex shapes.

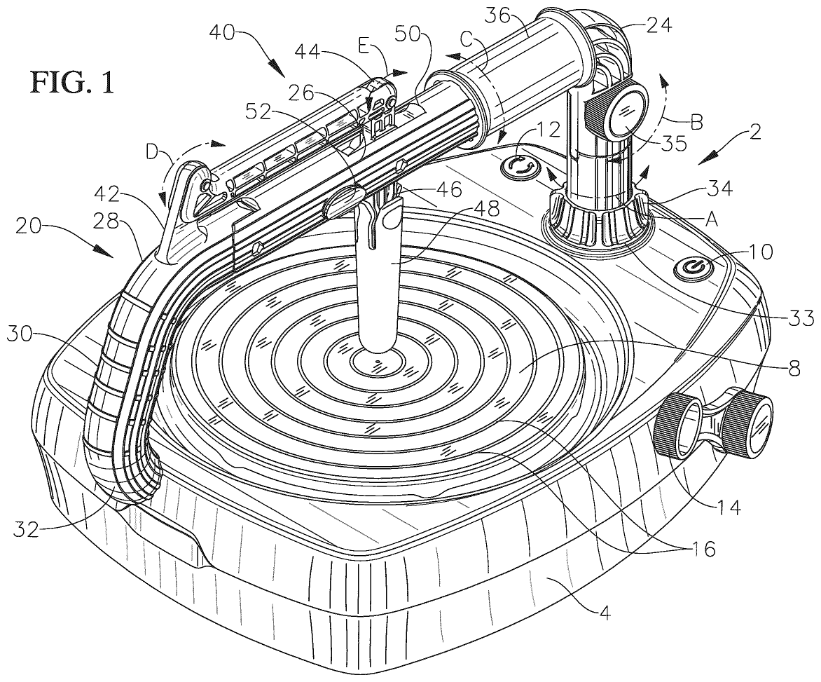

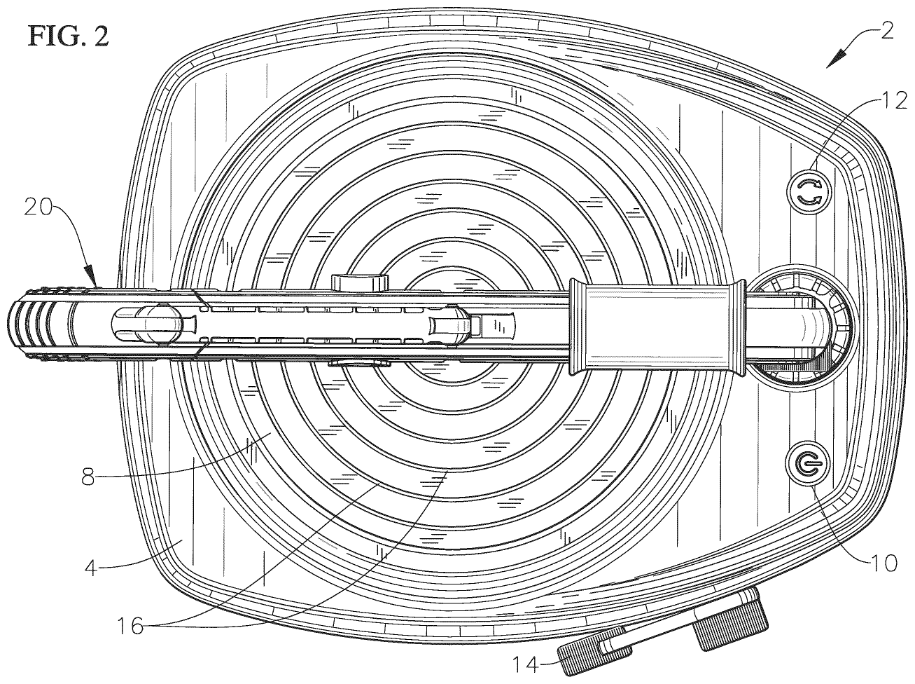

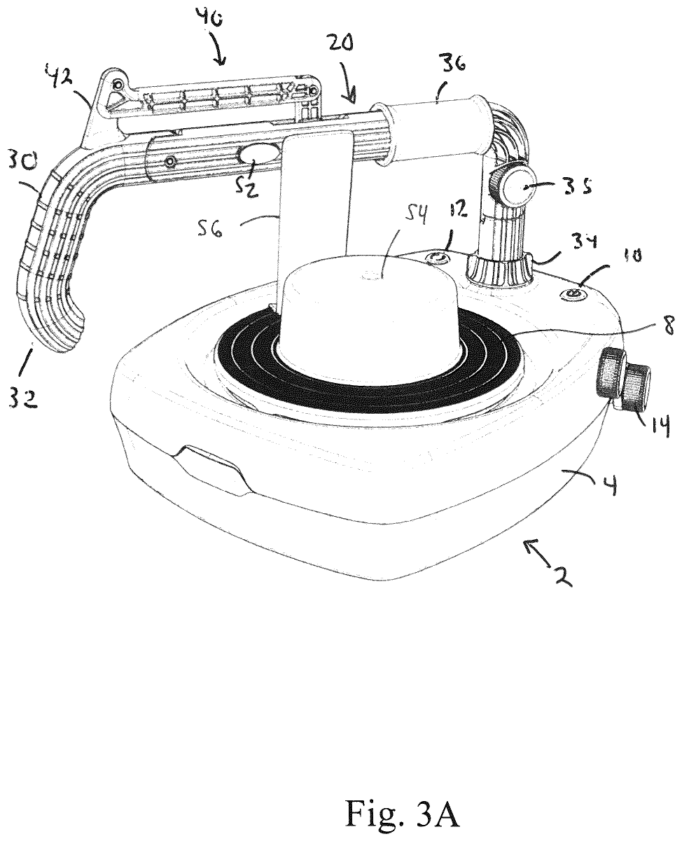

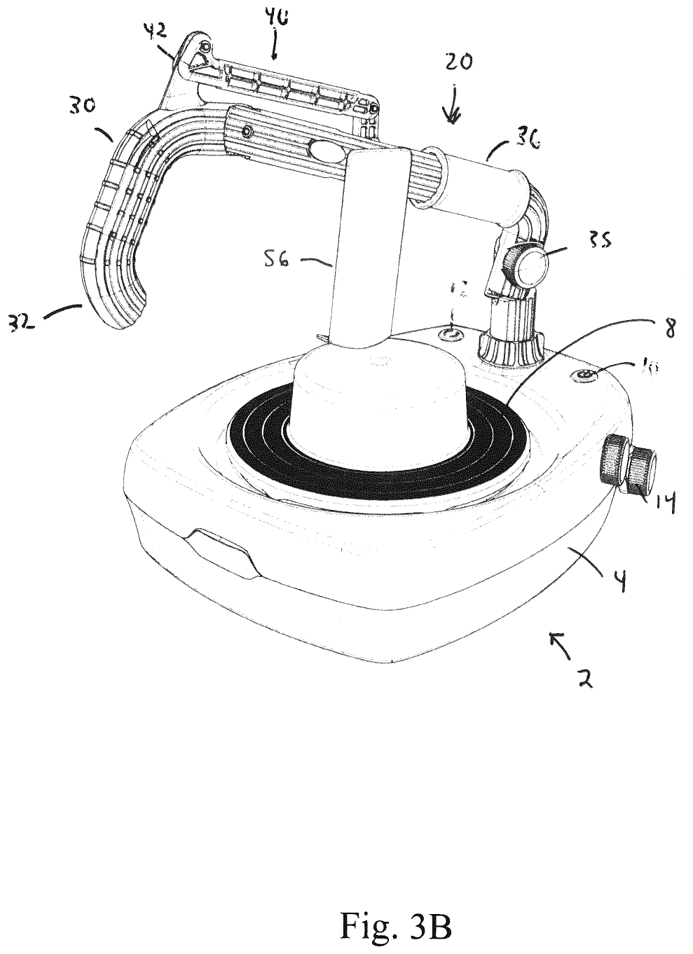

Referring to FIGS. 1 and 2, a pottery wheel 2, also referred to as a throwing wheel herein, according to an exemplary embodiment of the present invention includes a housing 4 encasing a motor (not shown), such as a rotary or magnetic or other suitable motor, upon which a spinning plate 8 is attached. The motor may be coupled to switches 10, 12 on the face of the housing that control the power and direction of the motor. The pottery wheel may include a lever 14, or alternatively buttons or a dial, that allows for the adjustment of speed to different settings. Though a circular spinning plate is shown, a plate of a different shape may be used, such as an octagon or other polygon, and present embodiments are not necessarily limited to a circular spinning plate. The spinning plate may have one or more demarcations 16 on the surface of the plate which will help the user to position the clay 54 (FIG. 3A) upon the plate, guide the position of the tools, and assist in sculpting the clay.

The pottery wheel may further comprise a throwing arm 20, also referred to as a tool arm herein, positioned on the upper surface of the housing, but preferably outside the perimeter of the spinning plate 8. The throwing arm may have a first generally vertical section 22 comprising two pivot points A, B, a rounded curved portion 24 which leads into a generally horizontal section 26 which extends across the length of the housing, and a second rounded curved portion 28 which leads into an angled handle 30, and terminating in a rounded tip 32. The handle may be ergonomically shaped and an appropriate size to be gripped by the hand of a user. The throwing arm may be removably attached to the housing at an attachment point 34, and may attach using a variety of different methods including a friction fitting, a flexible structure which snaps into place, screwing in, being secured by a clip or other fastener, or any other method of fastening known within the art. The throwing arm may be locked at pivot points A and B using rotatable locks 33, 35 respectively.

The horizontal portion may twist along the longitudinal access at a third pivot point C. This third pivot point located at the beginning of the horizontal segment of the throwing arm allows the tool attachment 48 to be rotated by the user twisting the throwing arm, possibly at the handle. This third pivot point may be spring loaded as to restore the throwing arm to a neutral position once the twisting force is removed. The third pivot point may also include a slidable lock 36 along the axis of rotation such that the throwing arm can be locked at various points including in a horizontally turned position, with a sculpting attachment pointing in a direction parallel to the face of the plate. This may allow for greater variability and movement of the centering arm and attached tools, allowing a user to sculpt the clay in additional ways. For example, when locked in such a horizontal orientation, the side of the sculpting attachment can be used to push the recently centered clay downwards, flattening the wobbly top of the clay, removing bubbles and dry spots in the clay, and uniformly moistening the clay.

In an exemplary embodiment, an appendage 40 is attached to the top forward portion 42 of the throwing arm proximate to the handle. The appendage is preferably attached to the throwing arm by way of a fourth pivot point D that allows the throwing arm to pivot up and down along the pivot point. In a resting position, the appendage extends back parallel to the horizontal portion of the throwing arm. The appendage extends toward an elbow 44 that pivots at a fifth pivot point E into a forearm portion 46 that extends downwardly into a slot 50 in the throwing arm. The forearm portion terminates into an attachment fixture 48, also referred to as an attachment prong herein, that may be fitted with a plurality of tools such as a centering tool and shaping tool, one at a time, to center and shape a clay workpiece. The appendage may be locked into place at a plurality of angles using a tabular lock 52 that releasably holds the forearm attachment in place at the desired pivot angle within the aperture using any one of a variety of suitable methods.

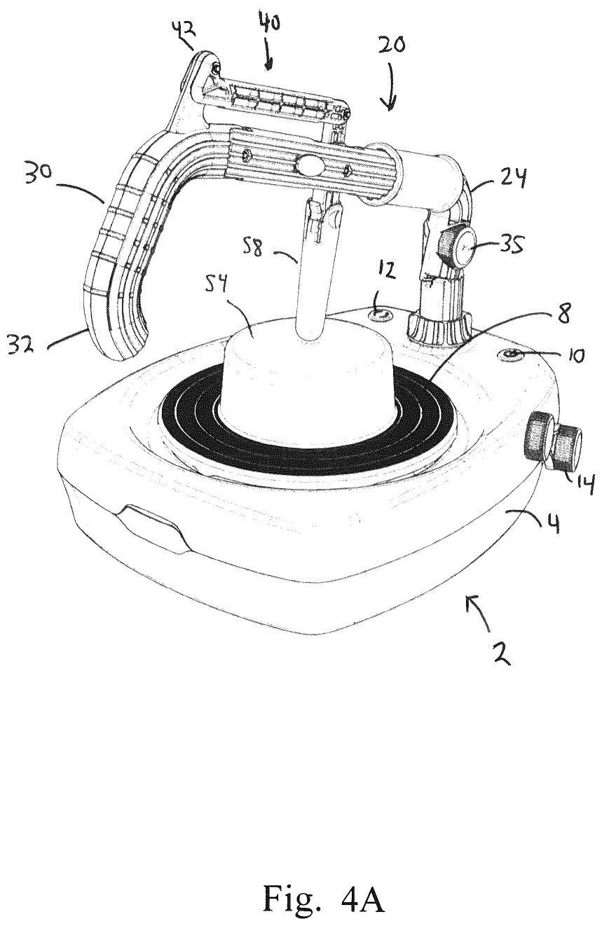

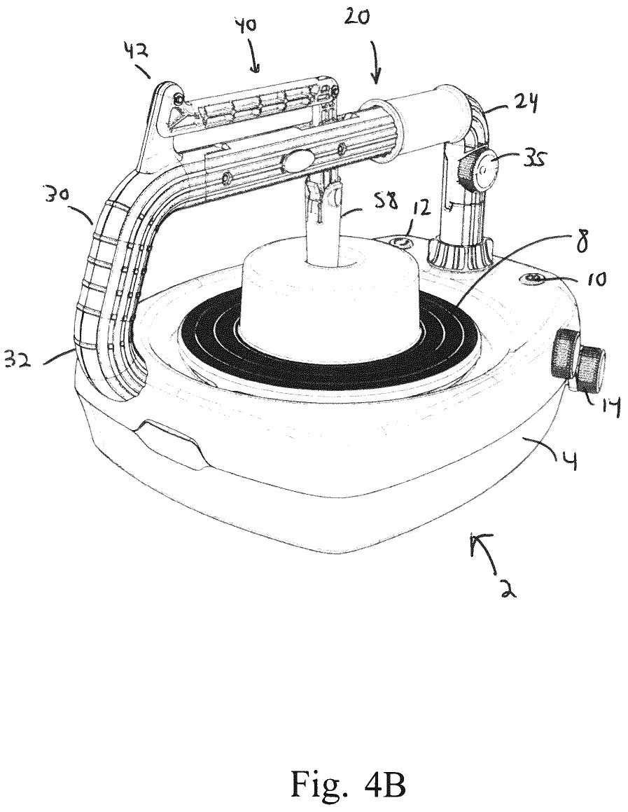

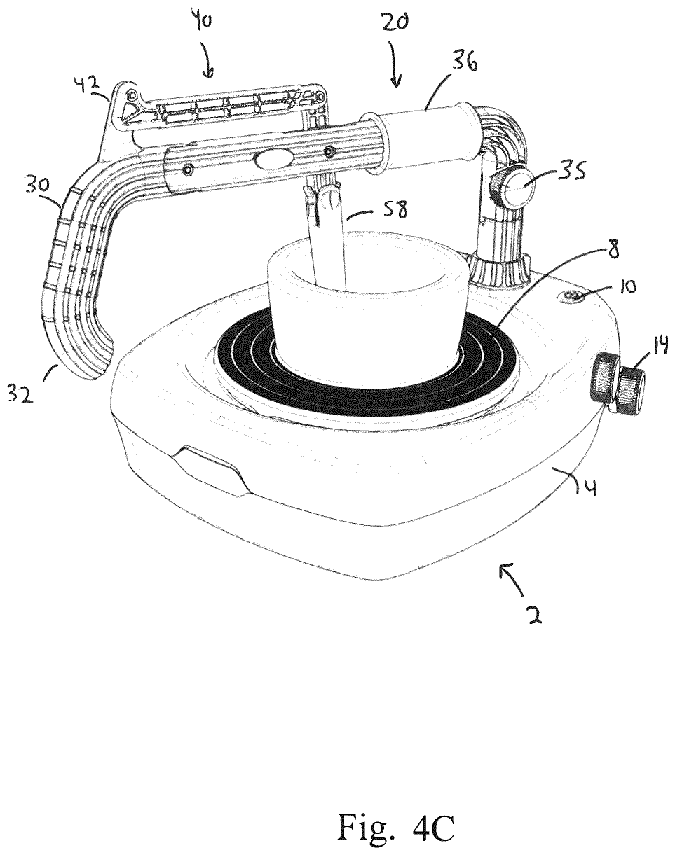

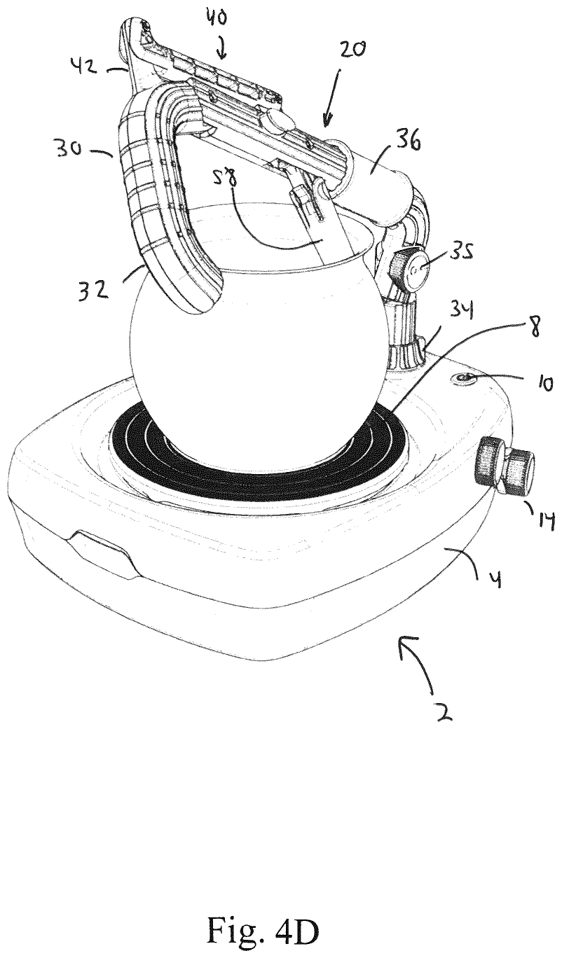

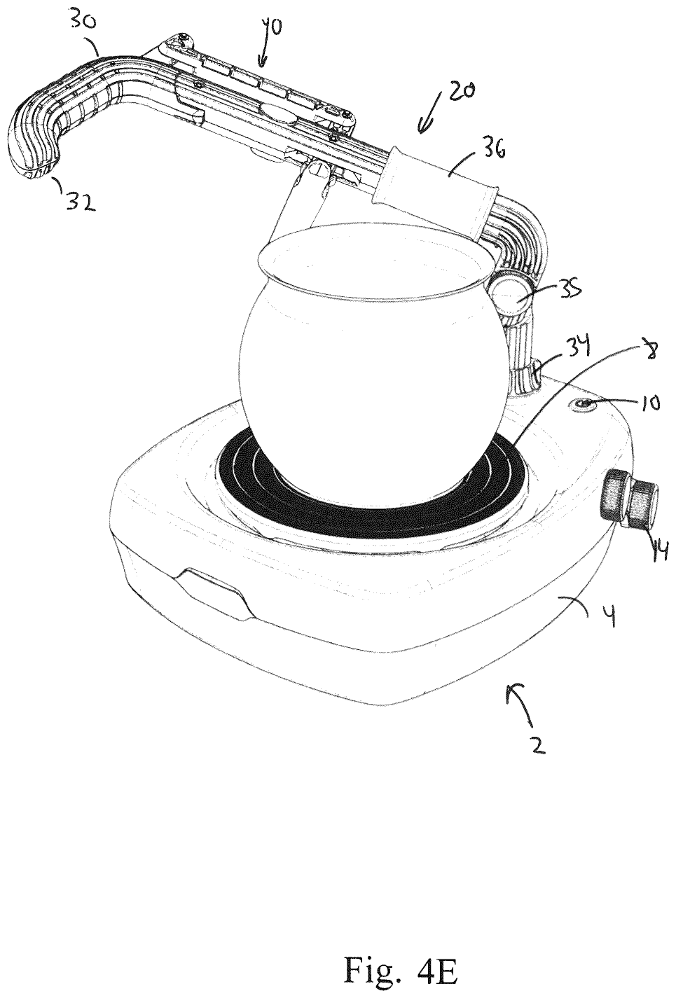

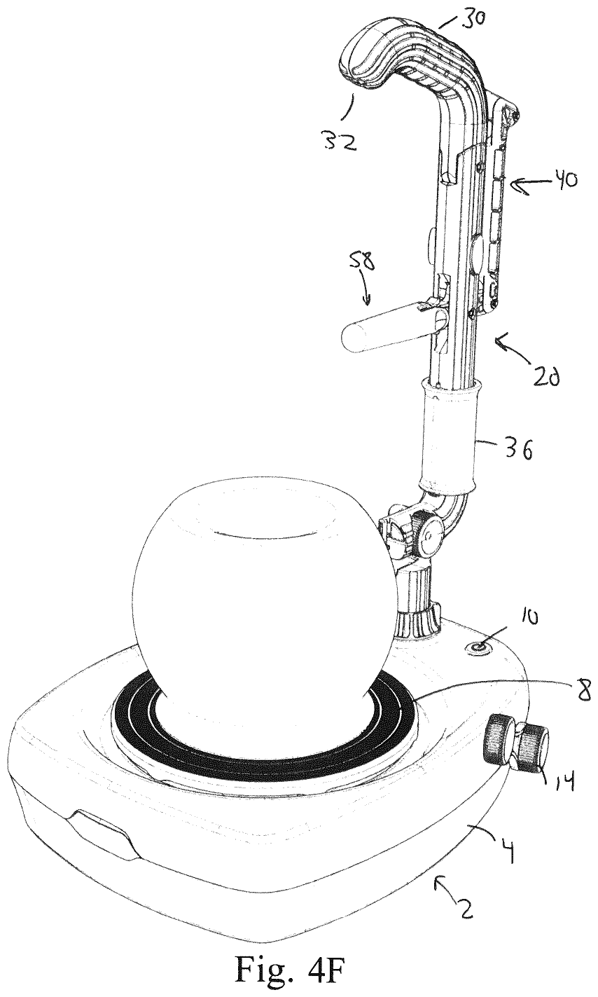

Referring to FIGS. 3A and 4A, the throwing arm with appendage may be configured to allow for the attachment of a variety of tools for forming a clay workpiece, including a centering tool 56 (FIGS. 3A and 3B) and an opening tool 58 (FIG. 4A). To center the clay, the attachment with the centering tool 56 may be locked in a vertical position (FIG. 3A) over the center of the plate and the throwing arm pivoted along pivot point C to engage the workpiece and round it to the center. The throwing arm and appendage may then be pivoted (FIG. 3B) to flatten or shape the top of the workpiece. To begin opening the center of the clay, the attachment with the opening tool 58 may be locked in a vertical position (FIG. 4A) relative to the horizontal portion of the throwing arm and pivoted downward along pivot point B toward the center of the spinning plate to open the clay at the center of the workpiece.

Referring to FIGS. 4B-4E, once centered and opened, the tool arm and appendage with multiple pivot and adjustment points allows multiple dimensions of articulation for the user to craft the clay workpiece into a wide variety of customized shapes. Referring to FIG. 4F, once completed, the throwing arm may be lifted away from the workpiece.

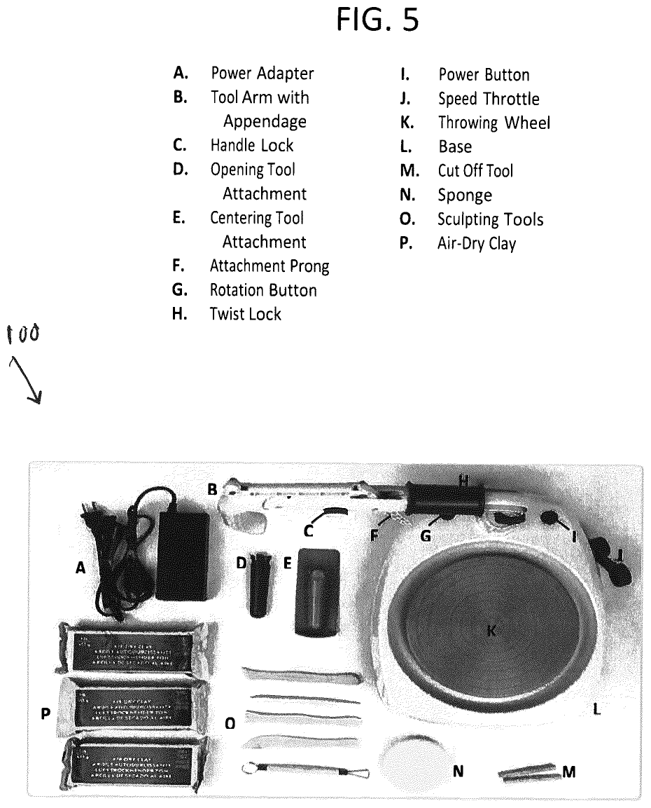

Referring to FIG. 5, an exemplary pottery wheel kit according to an exemplary embodiment of the present invention is preferably delivered as part of a kit that comprises a plurality of component parts (A-P) that may be assembled into a working embodiment.

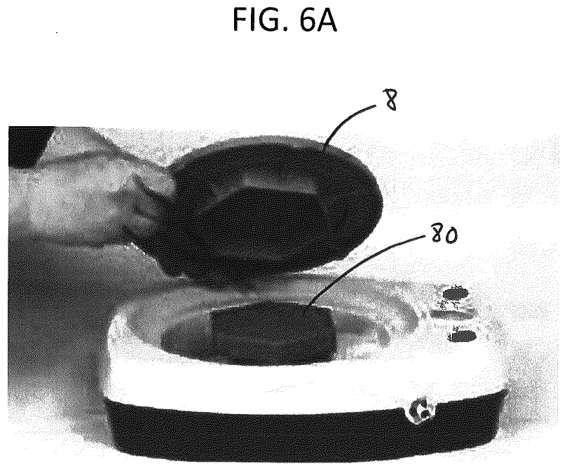

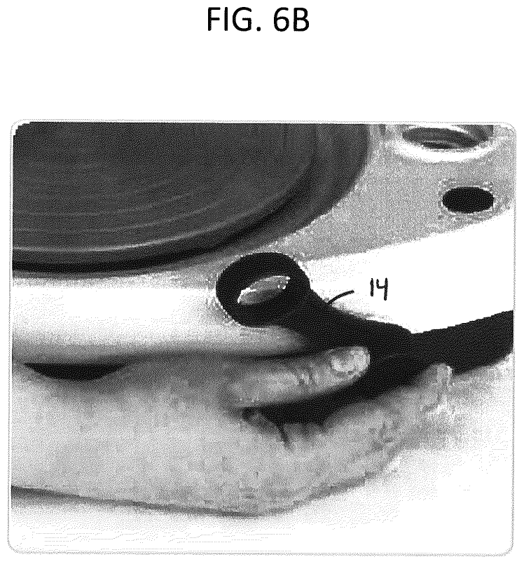

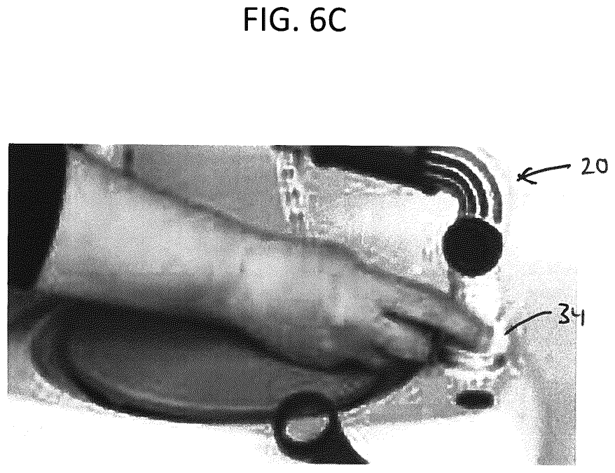

Referring to FIG. 6A, in an exemplary embodiment, the pottery wheel 8 may be assembled by first placing the wheel plate on the correspondingly shaped hex 80 located on the base. Referring to FIG. 6B, the speed throttle 14 may then be snapped onto the speed knob on the side of the base. Referring to FIG. 6C, the tool arm 20 may then be inserted into the threaded hole near the back of the base and the rotatable lock 34 may be tightened to secure the tool arm to the base.

Referring to FIG. 6D, the centering tool attachment 56 may next be inserted into the attachment prong. In an exemplary embodiment, the pottery wheel tool arm 20 may be positioned for right-handed or left-handed users, such that the user's dominant hand may articulate the tool arm without interfering with the workpiece positioned on the pottery wheel. For right-handed users, the tool arm should preferably be positioned so the flat side faces left. For left-handed users, the tool arm should preferably be positioned so the flat side faces right.

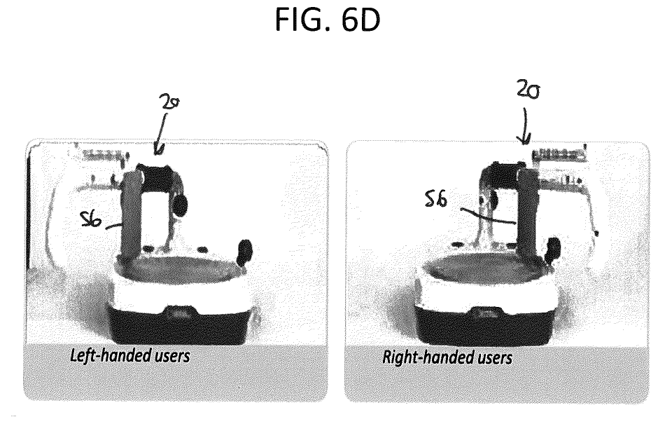

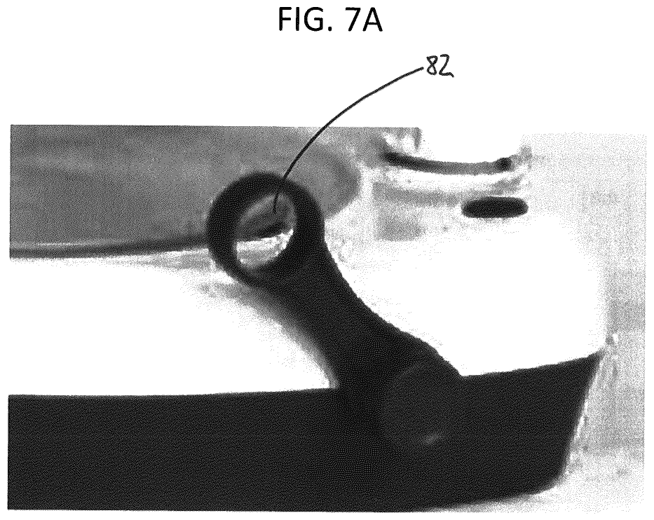

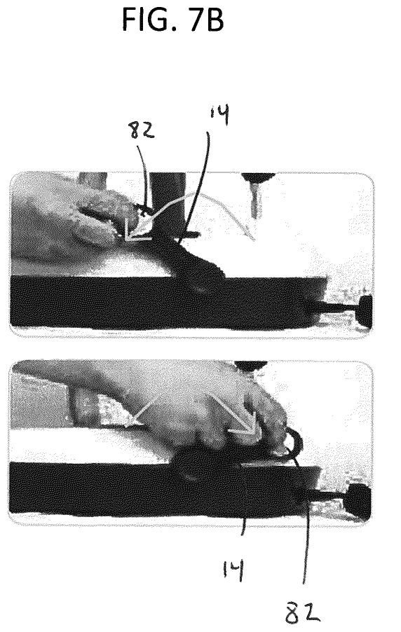

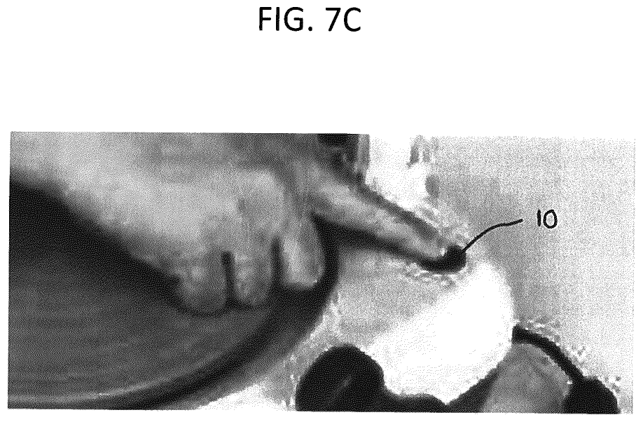

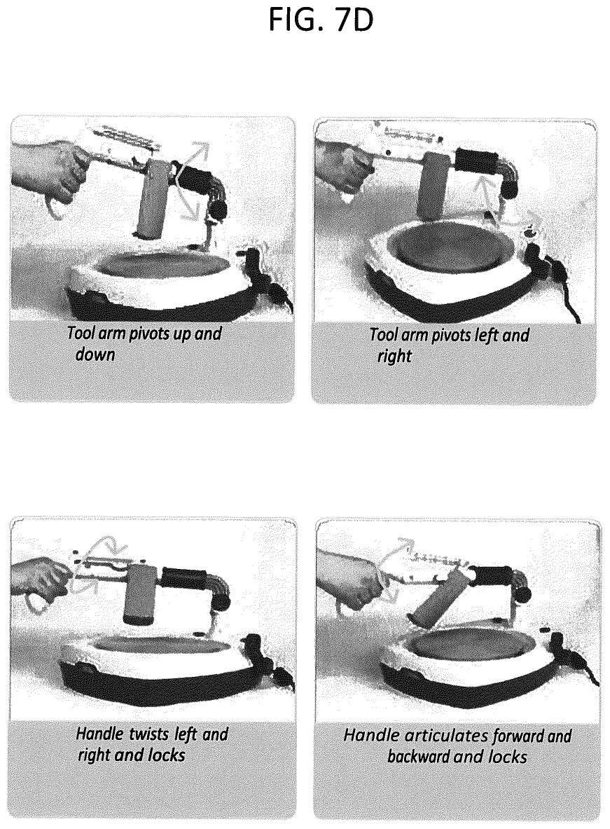

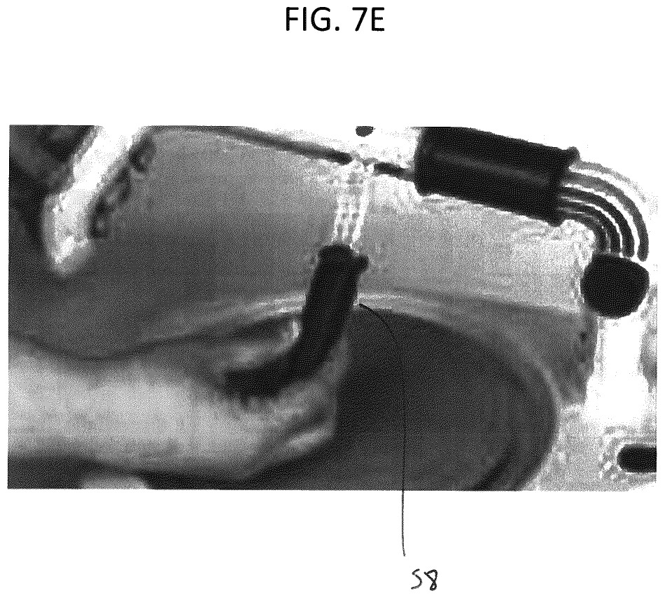

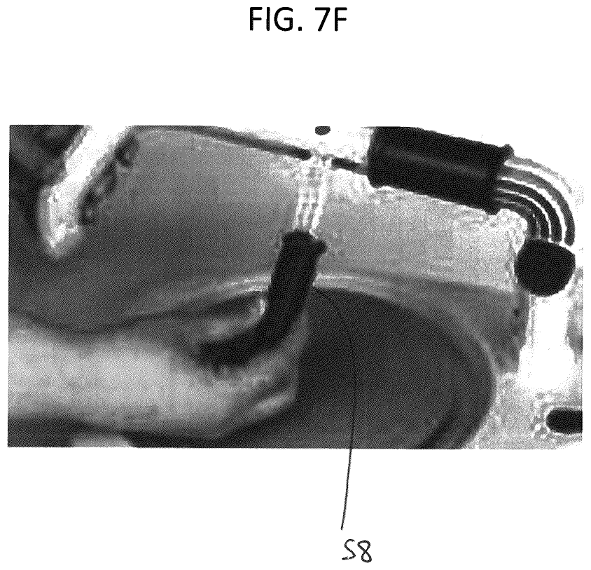

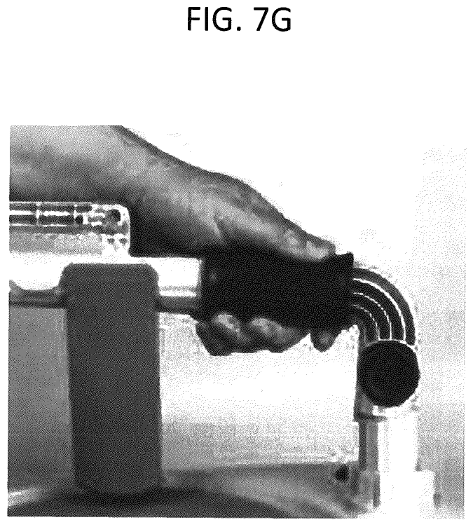

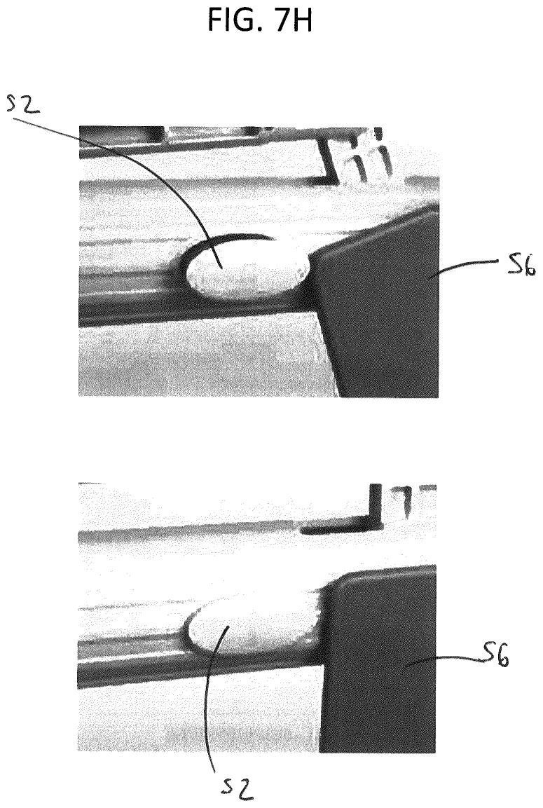

Referring to FIG. 7A, in an exemplary embodiment, to prepare the pottery wheel for use, the speed throttle 14 should preferably initially be placed in the OFF position, which in the exemplary embodiment is forward from the rear of the base. The speed throttle controls how fast the spinning plate spins. The speed throttle preferably has a finger hoop 82 for easy control when the user's hands are wet. Referring to FIG. 7B, when facing the pottery wheel, the user may pull the speed throttle toward the front of the base to decrease speed, and may push the speed throttle toward the rear of the base to increase speed. Referring to FIG. 7C, pressing the wheel rotation button 10 enables a user to spin the wheel clockwise or counterclockwise. For right-handed users, the selection of counterclockwise rotation is preferable. For left-handed users, clockwise rotation is preferable. In one exemplary embodiment, the user may use one hand to hold and manipulate the handle and the other to grip the base or the clay.

Referring to FIG. 7D, the tool arm provides multiple axis motion to enable the user multiple degrees of freedom to shape and form the pottery. In operation, the tool arm with appendage may be articulated in multiple dimensions along any of the pivot points A-E and may be locked as desired through any of the locking mechanisms. For example, the user may pivot the tool arm up and down and left and right and lock it in place. The user may also twist the handle left and right along pivot point C to lock it. The user may also articulate the handle up and down along pivot point B and lock it.

Referring to FIG. 7E, an exemplary tool attachment 58 may be installed in the exemplary embodiment by sliding it upwards on the attachment prong until it clicks in. Alternatively, referring to FIG. 7F, an attachment may be removed. To remove an attachment, the tool handle may be held while the attachment is pulled off of the attachment prong. In an exemplary embodiment, the tool arm preferably has two or more locks. Referring to FIG. 7G, sliding the twist lock toward the back of the base will preferably hold the tool arm in its current position. Referring to FIG. 7H, the handle lock 36 may be an oval button next to the attachment prong that is configured to demonstrate whether it is in the locked or unlocked position. In the exemplary embodiment, when the shaded or colored part of the lock is visible, the handle is unlocked. When the shaded or colored part is not visible, the handle is locked in position. This enables the user to maintain stability when centering, opening, and forming.

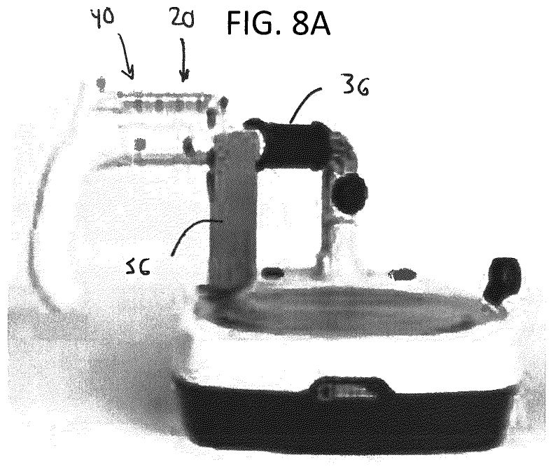

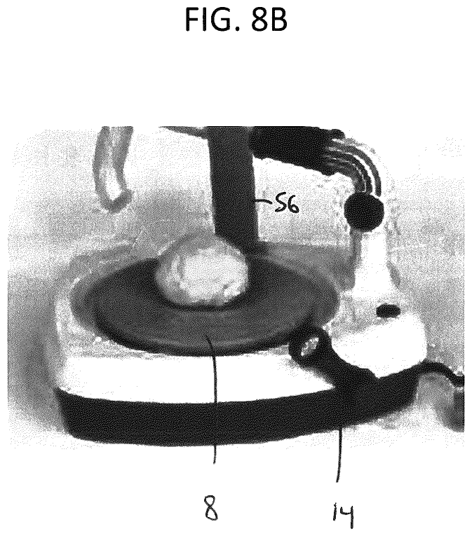

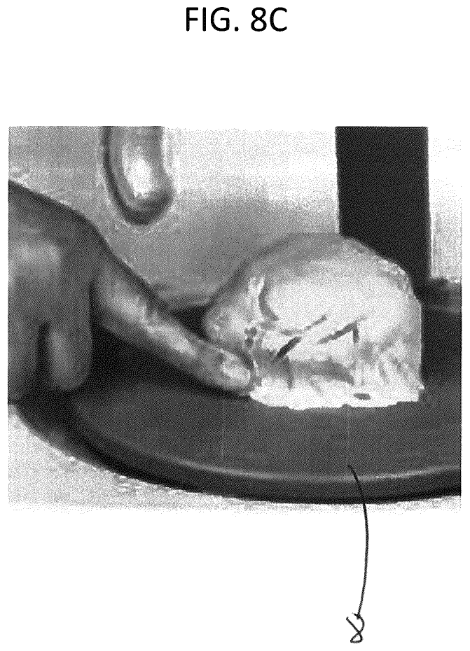

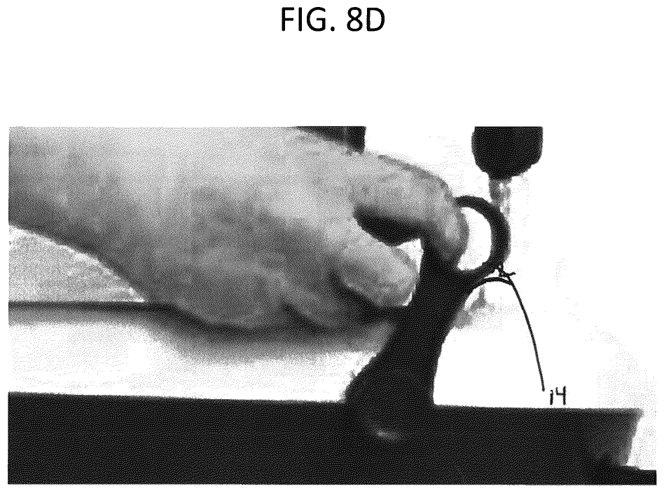

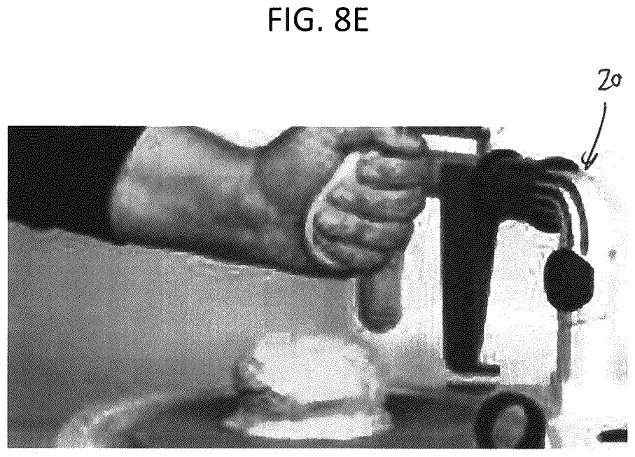

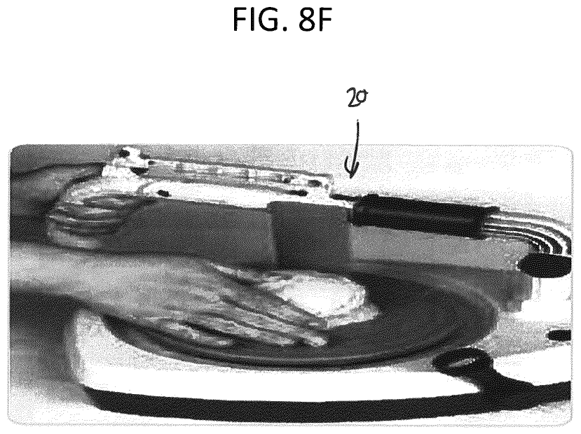

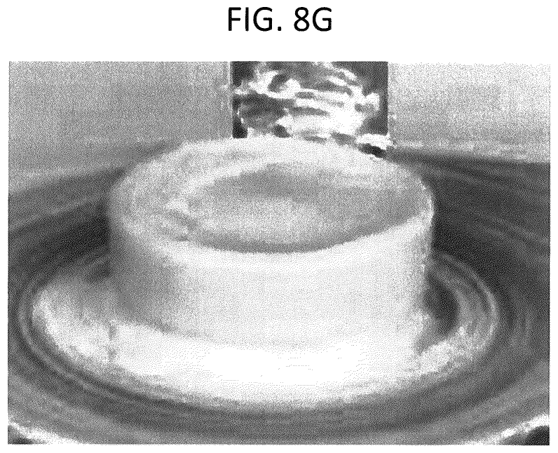

Referring to FIG. 8A, to throw clay on the spinning plate 8 and center it according to an exemplary embodiment, a user preferably first rotates the tool arm from the spinning plate and wipes the plate so it's slightly damp. Referring to FIG. 8B, the user then preferably presses the clay ball onto the center of the throwing wheel 8. Referring to FIG. 8C, the user then preferably pushes down the bottom edges of the clay ball with their finger, so the clay sticks to the spinning plate. This creates a suction effect in the exemplary embodiment that helps adhere the clay to the pottery wheel. Referring to FIG. 8D, the user then preferably turns on the pottery wheel 2 and pushes the speed throttle 14 forward to achieve a medium rotation speed. Referring to FIG. 8E, the user preferably uses the sponge to squeeze water onto the clay until the surface is visibly wet.

Referring to FIG. 8F, the user then preferably holds the tool arm by the handle and moves the centering tool 56 attachment toward the clay, just touching the surface of the spinning plate. While holding the tool down against the spinning plate 8, the user preferably presses slowly and gently toward the center of the pottery wheel against the clay. At the same time, using the palm of their hand, the user cups the side of the clay and places their thumb on top. The user's palm helps keep the clay centered, and the user's thumb helps keeps the top of the clay flat. If the clay begins to stick to their hand, the user may preferably add more drops of water as needed to the surface of the clay, their hands, and/or the centering tool to keep all points of contact wet during this process. Referring to FIG. 8G, the user may know the clay is centered when the shape resembles a puck or cylindrical shape, and the clay is not wobbling. Once the clay is centered, the user may preferably move the tool arm away from the clay, pull the speed throttle 14 to the OFF position, and remove the centering tool attachment 56.

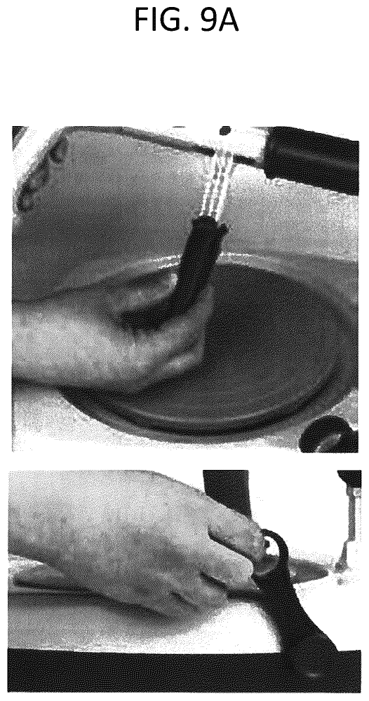

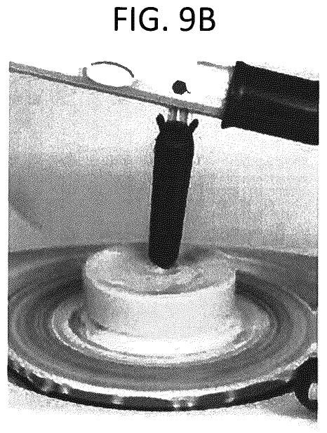

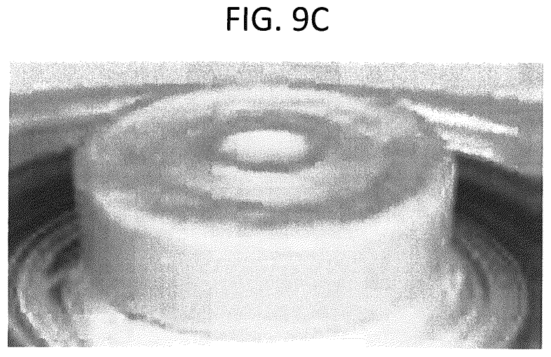

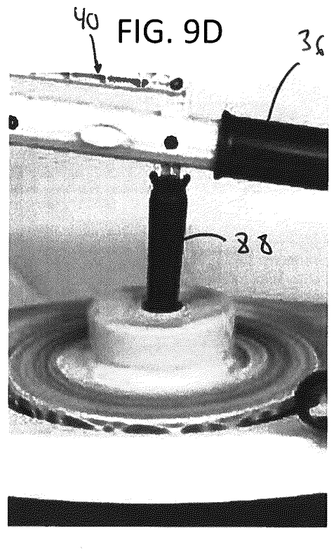

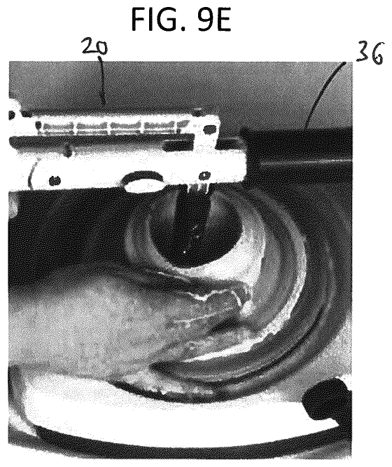

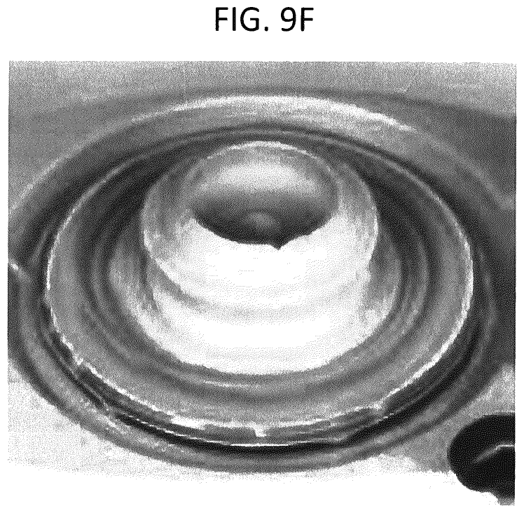

Referring to FIG. 9A, to open the clay toward creating a pottery piece such as a bowl, the speed throttle should preferably be turned OFF, and the twist lock and attachment lock should be set in the locked position. The user may them replace the centering tool with the opening tool on the tool attachment. Next the user may power on the wheel and increase the speed throttle to a slow-medium speed, while preferably adding some water with the sponge. Referring to FIG. 9B, the user preferably holds the tool arm by the handle and lowers the opening tool so it meets the center of the clay like a bull's eye on a target. At the same time, the user should preferably cup their other hand around the side of the clay to help keep it centered. Referring to FIG. 9C, the user preferably makes a small divot with the tip of the opening tool in the center of the clay, then raises the tool arm. The user may then add a few drops of water with their fingers to the divot in the clay and lower the opening tool into the clay again to make the divot deeper. The user may continue adding water as needed. Referring to FIG. 9D, to adjust the diameter of the opening, the user may preferably hold the tool arm by the handle and brace the outer surface with their other hand. The user may preferably cup their hand to the shape of the clay and apply light, consistent pressure to the outer surface. Referring to FIG. 9E, the user may pull the handle of the tool arm outward slowly and deliberately to open the clay to the preferred diameter, keeping their hand in the brace position on the outer surface, ensuring the vessel remains round and centered. The user should preferably keep constant pressure on the inner and outer walls of the clay while opening. Referring to FIG. 9F, the user may open the clay to their desired diameter, pull the speed throttle 14 to the OFF position, and move the tool arm 20 aside to remove the opening tool attachment.

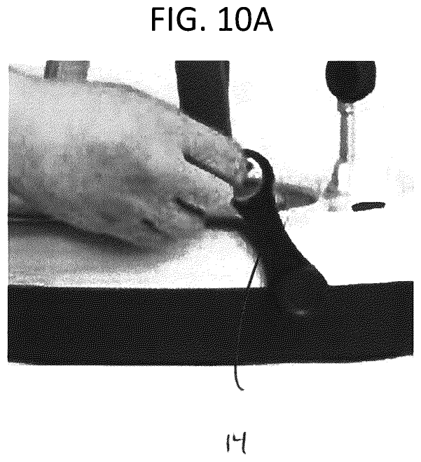

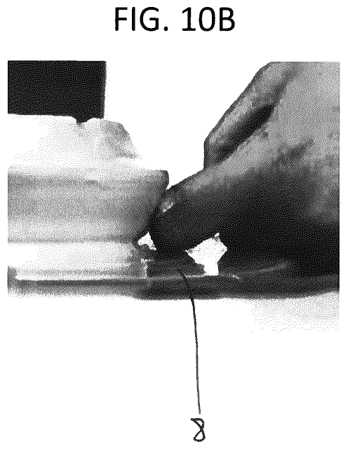

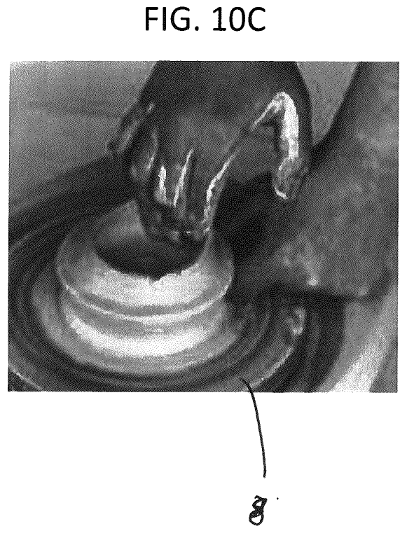

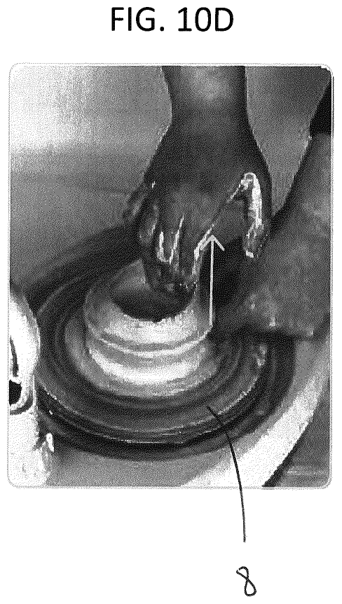

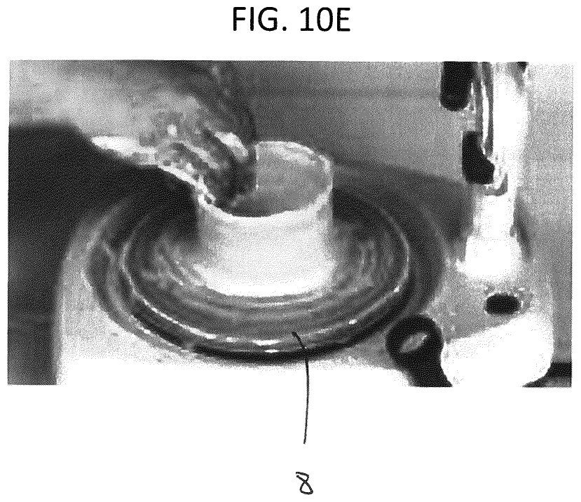

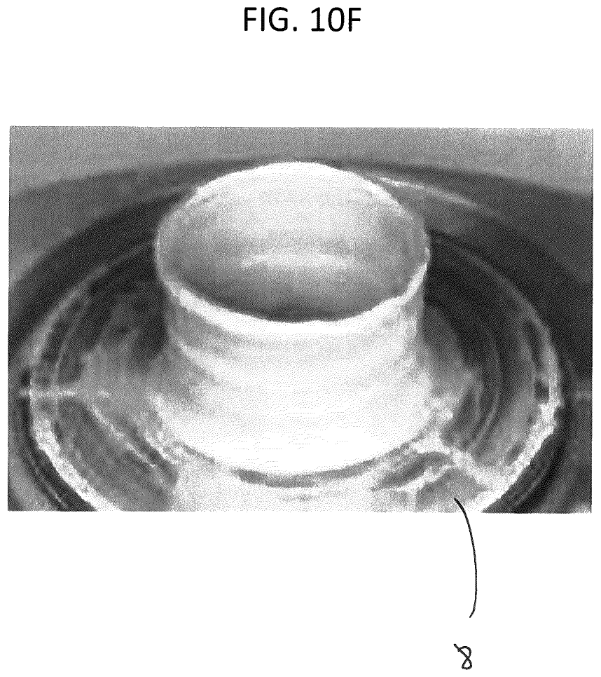

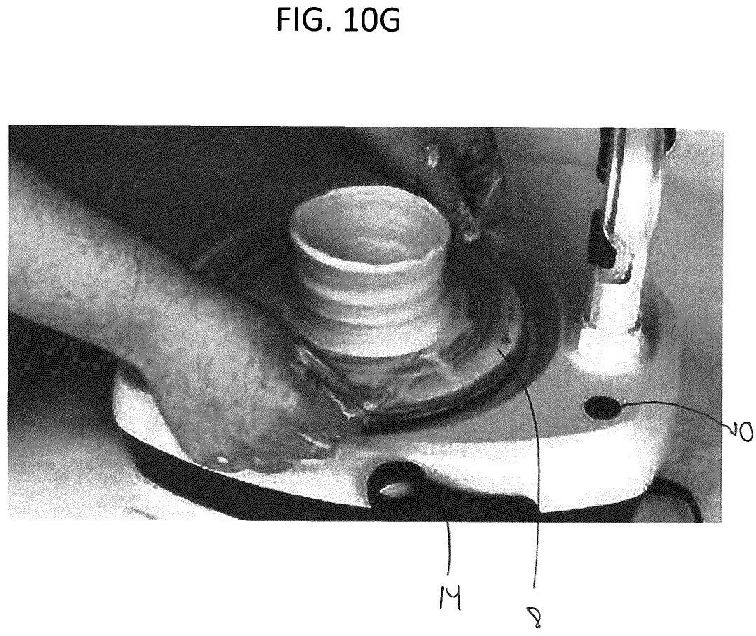

There are many ways to shape the clay as known by those skilled in the art, with the following representing one example. To begin the shaping, the user should preferably add plenty of water so that the clay and their hands stay wet. Referring to FIG. 10A, the user should first pull the move the speed throttle slowly forward from the OFF position to a slow position. Referring to FIG. 10B, the user may preferably tuck their elbows into their sides to ensure a strong, braced position. With their dominant hand on the outside of the clay, the user may preferably make a first and gently press the side of the clay with their pointer finger knuckle against the clay base. This will create a clay ring above their knuckle that is pressed against the clay. This is the clay they can then “pull” up.

Referring to FIG. 10C, in the exemplary embodiment, the user may then place their three middle fingers of their other hand inside the vessel, slightly below the outside knuckle. At the same time, the user may place their thumb on top of their dominant hand to brace. Referring to FIG. 10D, in the preferred embodiment, the user may preferably keep this position throughout the “pull” to ensure even clay wall thickness. Holding this position, the user may gently and slowly move their arms (preferably not their wrists) up to create a cylindrical shape. The user may go slow, preferably ensuring the wheel makes one full rotation before pulling up. Referring to FIG. 10E, in the preferred embodiment, the user may repeat this process several times (e.g., three or four times) until the clay wall is ¼ inch thick in one exemplary embodiment. With this process, the user may create a cup. Referring to FIG. 10F, to make a bowl, the user may preferably use the same hand position and gently pull the clay out to the 3 o'clock position.

Air-dry clay may be delicate, especially if it becomes too wet. If the clay cracks while being thrown on the pottery wheel, the user may preferably reduce the speed to half speed or less. The user may then pinch the inner and outer walls together gently, applying slow increasing pressure, which should enable the cracks to join back together. The user may stop the pottery wheel occasionally to check progress. If the cracked clay is too saturated to join back together, the user may remove it from the pottery wheel and let it sit for a few hours to dry out, before throwing it again. Alternatively, if the clay continues to crack or is difficult to throw, the user may shape the clay by hand.

Referring to FIG. 10G, the user may turn off the wheel once they are pleased with the shape of the clay to remove and cure the clay. The user may then use the sponge to squeeze water onto the surface of the wheel. The user may then grasp the cut-off tool and pull it taut with both hands so there's no slack. The user may then press the string of the cut-off tool down into the wheel surface with their thumbs, making sure the string on the pottery wheel surface is wider than the vessel. The user may then pull the string of the cut-off tool toward themselves along the pottery wheel surface in a smooth, controlled motion. In one exemplary embodiment, the user may keep the cut-off tool string on the pottery wheel surface and keep the string tight as they pull underneath the clay so the base stays as level as possible. Once the clay is separated from the pottery wheel, the user may clean and dry their hands before gently picking up the piece and placing it on a non-porous surface in a secure location to dry. In a preferred embodiment, the clay should sit for at least 24 hours to dry or at least until the workpiece has hardened sufficiently.

The configuration of a throwing arm extending across the length of the pottery wheel that pivots in multiple directions with at least two directions being towards the center of the plate also represents a significant improvement over prior art in that it allows for the improved centering of clay blocks about the axis of rotation precisely in the middle of the spinning plate. In general, positioning a block of clay precisely in the middle of the spinning plate is among the greatest challenges for new sculptors when using a pottery wheel, as even a small distance off center leads to an uneven application of force to the perimeter the clay as it rotates about the axis of rotation, in the center of the plate, resulting in an asymmetric and aesthetically unappealing product. Once centered, the multiple degrees of freedom offered by the exemplary pottery wheel allows the user to engage the workpiece at a wide variety of different angles and touch points to create increasingly complex and customizable pottery sculptures.

The exemplary pottery wheel, including its housing, throwing arm, appendage, fasteners, and spinning plate may be composed of a plastic, a polymer, aluminum, stainless steel, another metal, or any other suitable material. The exemplary pottery wheel in one embodiment may be composed of ABS or polypropylene. The throwing arm may be composed of aluminum or other metal, as well as its other components using an increased power motor. The exemplary pottery wheel may be manufactured by casting, molding, 3D printing, or any other method of manufacturing suitable for the chosen material.

One of ordinary skill in the art will recognize the inventive principles disclosed are not limited to the embodiments disclosed herein, and that various aspects of the disclosed embodiments can be combined to achieve additional embodiments. The applications of the present invention have been described largely by reference to specific examples and in terms of particular allocations of functionality to certain components. However, those of skill in the art will recognize that the invention can also be produced by components that distribute the functions of embodiments of this invention differently than described. Such variations and implementations are understood to be captured according to this disclosure.

What is claimed is:

1. An apparatus, comprising:
a housing;
a rotary motor within the housing;
a spinning plate attached on an upper surface of the housing powered by the rotary motor configured to spin in at least one direction;
a throwing arm positioned on the upper surface of the housing outside the perimeter of the spinning plate,
wherein the throwing arm is configured to pivot around a first point in two directions with at least one direction being towards the center of the spinning plate,
wherein the throwing arm is configured to pivot around a second point in two directions with at least one direction being towards the center of the spinning plate, and wherein the throwing arm is configured to attach to at least one tool.
